(19) United States
(12) Patent Application Publication
(10) Pub. No.: US 2016/0162784 A1
(43) Pub. Date: Jun. 9, 2016

(54) SYSTEM AND METHOD OF INCORPORATING VISUAL DATA INTO ELECTRONIC VERBAL BROADCAST

(71) Applicant: SUDHAKAR REDDY VINTHA, FREMONT, CA (US)

(72) Inventor: SUDHAKAR REDDY VINTHA, FREMONT, CA (US)

(21) Appl. No.: 14/953,314

(22) Filed: Nov. 28, 2015

Related U.S. Application Data
(60) Provisional application No. 62/086,558, filed on Dec. 2, 2014.

(51) Int. Cl. G06N 5/02; G06F 3/16; G06Q 30/02; H04L 29/08; G06F 17/30

(52) U.S. Cl. CPC G06N 5/02; H04L 67/10; G06F 17/30569; G06Q 30/0255; G06F 3/165

(57) ABSTRACT

An end to end intelligent visual insertion system and method for an adaptive content management is designed to implement a practical and enjoyable approach to listeners and users by the podcasts, lectures or electronic book providers by adding a visual data to further clarify their talks, literature work or a talk. They would be able to insert and visualize a particular and pertinent picture at an appropriate time and duration during their listening or reading experience using edge devices.

### CROSS REFERENCE TO RELATED APPLICATIONS

This application claims priority to U.S. Provisional application 62/086,558 filed on 2 Dec. 2014. The disclosure of the pending application is hereby incorporated by this reference in its entirety for all its teachings.

### FIELD OF TECHNOLOGY

This disclosure relates generally to an integrated enterprise system to enable and display visual data into a verbal electronic broadcast for effective communication. More particularly the disclosure details how to insert and create visual input in real time and manage the implication of change for resources using a system and a method.

### BACKGROUND

Most often, people reading the books take a lot longer than those using audio books. Audio books, being comparatively a new concept, were started when tapes became cheaper and portable. This concept was carried to smart devices, where audio books were heard using earphones after downloading through apps such as Oneclick digital and Overdrive. The visual display of the smart devices largely remains unused by audiobooks. The important point of this invention is to use both visual and audio stimulus to complete a content transfer through technology means.

Audio books without visual aid are cumbersome, especially when an author is explaining a concept such as graph or matrix. The more the book is scientific and data oriented, the more complicated the explanation tends to be without visual display support.

Cellular phones are ubiquitous in the world today with connectivity to people right across the spectrum in terms of their earning capacity. The sheer number of cellphones and its usage creates great opportunity to disseminate information on educational materials to individuals. In addition, laptops and desktops are present at home and educational institutions allowing direct imparting of educational verbal broadcast to people anywhere, anytime and anyplace. The verbal broadcast, namely podcast, material really broad to general population need not be educational, and it could be any content. For example, it could be fictional stories.

Podcasts, electronically accessible lectures are a great tool for presenters to communicate with audience. They are very useful tools to gain more knowledge and enjoy knowledge enhancement in the busy world of working class folks. The children also are very electronically savvy and would like the old story telling method to be incorporated on mobile devices such as tablets, IPads, cellphones etc. However, the visual that accompany these methods of communication are static and sometimes not even accessible.

There is a need for a more animated display of the content for matured as well as children. In general, the animated display is needed for better understanding of the context when a pure audio lacks that.

### SUMMARY

Several embodiments for a system and method for intelligent visual insertion for verbal broadcast containing mobile communication optimization, cloud computing, targeted advertisements, emergency preparedness, analytics, and back-end intelligence providing context free and context sensitive messages are disclosed. Several embodiments for an intelligent visual insertion mechanism for verbal broadcast are disclosed.

In one embodiment, an intelligent system and a method are created to display, manage and time enterprise wide visual data management for electronic verbal files such as podcast, talks, presentations and published electronic books that have text or verbal only format files. This allows the user to not only visualize what the speaker is conveying but also get a better understanding of the data that is being presented and in the case of fictional and non-fictional books a better visualization of the plot. In another embodiment, a network module enables the content and context manager for this to communicate efficiently with the content creator and the content user using cloud based and Internet based systems. In one embodiment, the image management module is a repository for the images either specifically created for the content or provided by the content creator.

In another embodiment, a regulatory module is implemented to comply with local government rules such as copyright and contracts, for procuring and disseminating the visual files for the electronic verbal files. In one embodiment, an intelligent mechanism to optimize visual insertion to a voice broadcast tailored to data challenging environments such as mobile network, cellular network, wireless network and satellite network is presented. In one embodiment, a unique intelligent visual insertion technology is proposed to the voice broadcast that can work at multiple levels over cloud presenting concisely to the level of information expected by the user.

Several embodiments for an intelligent mechanism where visual data advertisement and messages is available for a target audience that uses voice broadcast to learn. In one embodiment, an intelligent system that provides cultural or crowd sensitive visual inserts, for example providing an illustration in local language, during a voice broadcast is proposed.

In one embodiment, an intelligent system and method to handle emergency related messages as visual inserts during a verbal broadcast to a group that is collocated or dispersed is proposed. In one embodiment, an intelligent system that combines the context free and context sensitive messages as visual inserts seamlessly is proposed. Several embodiments for an intelligent system that gathers analytics of a group behavior during voice broadcast and visual inserts is proposed.

This system and method relates to a method comprising the cloud and wireless, including cellular, based visual data dissemination over electronic verbal broadcast by interfacing with front end edge devices; back end intelligence and the base station. This system and method relates to the cloud and cellular based visual data dissemination over electronic verbal broadcast system by adaptively learning the customer requirements and providing functions to keep the service without disturbing the context.

This disclosure relates to collection of the customers watching the video over the visual broadcast within the broadcast crowd, to which targeted service including telephony, data connectivity, advertisement, location services and emergency preparedness can be provided.

This system and method relates to serving the customers during predefined time period (temporal) and predefined destinations (spatial) when customers require verbal and visual broadcast. This system and method relates to a fixed and diverse broadcasting that caters to the customers who are logged in with various forms of technology including mobile phone and user devices. This system and method relates to a visual data over voice broadcast that is context free serving the same content to a general diverse dispersed population.

This system and method relates to a visual data over voice broadcast this context and location sensitive serving same content while providing context sensitive advertisement, content and emergency preparedness data serving the participants. This system and method relates to the comprehensive cloud based analytics learning behavior intelligence backend expert system. This system and method also relates to the expert system providing forensic analysis using the knowledge base to the expert learning investigators and analysts for research purposes.

In one embodiment, intelligent analytics engine in the back-end calculates the pulse of the user and gathers data that can be used for enhancing the user experience by providing targeted data. In one embodiment, the intelligent analytics engine correlates the behavior to suggest new topics for the user that enhances the user knowledge and takes them beyond the present scope of the topic in visual inserts.

The methods and systems disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 illustrates a view of a system for visual data management technology through a device.

FIG. 2 shows the representation of different modules being used through a processor.

FIG. 3 illustrates the flow chart for the proposed visual data insertion technology.

FIG. 4 shows another embodiment of the flow chart for technical decision making.

FIG. 5 shows the display of the audio book and insertion of the picture display.

FIG. 6 illustrates another embodiment of the audio book display on a mobile device.

FIG. 7 shows various podcast displays with visual graphs and examples.

FIG. 8 illustrates the visual insertion e-learning sphere of influence.

FIG. 9 shows the visual insertion intelligence high level network architecture.

FIG. 10 shows the backend intelligence system subcomponents.

FIG. 11 illustrates the visual insertion intelligence module dependencies.

FIG. 12 shows the video insertion process within the backend intelligence.

FIG. 13 shows the emergency preparedness intelligence module dependencies.

FIG. 14 illustrates the use case for visual insertion into audiobook.

FIG. 15 shows the functional flow chart.

FIG. 16 shows the system description work flow.

Other features of the present embodiments will be apparent from the accompanying drawings and from the detailed description that follows.

### DETAILED DESCRIPTION

Several method, process and systems for intelligent visual inserts over a verbal broadcast system with optimization, analytics, messaging and emergency preparedness are disclosed. Although the present embodiments have been described with reference to specific example embodiments, it will be evident that various modifications and changes may be made to these embodiments without departing from the broader spirit and scope of the various embodiments.

Visual data insertion into verbal audio broadcast is important in mobile communication. Most smart phones nowadays have the capability of audio visual I/O. In most of the cases, an individual who is taking long distance transportation to office or sits in a secluded place to listen to audio would require the relevant visuals to enhance the understanding of the subject. For example, when a presentation is done in a meeting, the smart phone has the capability to display video. However, most cellphones are using a plan where unlimited data is not available. Hence a clearly selected insertion of visuals over a voice broadcast optimizes the mobile communication bandwidth, while achieving the crucial need of transmitting information to a group of people over mobile broadcasting medium. Presently, there is no mechanism that is available where an optimized visual insertion to a voice broadcast tailored to data challenging environments such as mobile network.

Today's productive world, not all the broadcast are done real-time. Due to time pressure, people are allowed to listen and watch the broadcast at their convenience. For example, if a CEO is presenting the quarterly report of the company to the shareholders, it is not necessary all the shareholders have to listen to the broadcast at the same time. On the other hand, it is not very convenient to expect every shareholder to read the annual report in print form to know what was broadcast if they missed the event either. In our invention, the visual insertion to an audio broadcast can be done over the cloud where it is automatically updated and present for people to access 24×7. Presently, there is no visual insertion technology available to the voice broadcast that can work at multiple levels over cloud presenting concisely to the level of information expected by the shareholder.

Marketing has changed over the past decade with effective personalized marketing of products preferred that is catered to the need of the advertiser and the customer. If a group of people are signed for a broadcast, then the group's characteristic, such as age, gender, profession, etc., is clearly known. In this context, it is important to find the right group of people who can be targeted for a particular product advertisement. In our invention, we propose a unique marketing engine that provides targeted intelligent advertisements to the group that is being broadcast. The visual data insertion has the component of the voice broadcast and advertisement. Today, there is no technology that is available where a visual data advertisement is available for a target audience that uses voice broadcast to learn.

With e-learning becoming very prevalent, the distance between the student and teacher is not an issue anymore as long as the communication medium is set up. Distance education has taken deep root in countries such as Nepal where people in a village listen to lectures from MIT and Stanford. The proposed visual insertion over voice broadcast optimizes and enhances the learning experience of the students with context sensitive visuals that are cultural and background specific. Presently, there is no cultural or crowd sensitive visual inserts, for example providing an illustration in local language, during a voice broadcast.

Emergency preparedness is an important domain where there is a need for a group of people to be reached over a communication medium all at the same time. For example, the emergency preparedness message could be simple visuals of where the fire exits are. It could also be a real-time message to convey clear and present danger. When a group of individuals login to the voice broadcast system from same place, such as a night school e-learning center, the visual insertion not only enhances the quality of the content, but also provides a mechanism through which emergency messages can be relayed thus enhancing emergency preparedness. Presently, there is no mechanism to handle emergency related messages as visual inserts during a verbal broadcast to a group that is collocated or dispersed, say in exam halls.

Analytics is an important mechanism to sharpen the message. In order to understand the group behavior, statistics is gathered regarding the time spent, interest level, gender, age, etc. For example, if a person rewinds to a particular topic quite often that shows that there is a need for enhancing that subject material. In our proposed invention, the back end intelligence takes analytics into account. Presently, there is no intelligence system that gathers analytics of a group behavior during voice broadcast and visual inserts.

The visual insertions can either be context free related to content, or context sensitive related to the group. Context free messages enhances the content by providing additional visuals, while the context sensitive messages target the audience interest through visuals such as advertisements. The back end intelligence of the proposed intelligence allows multiple layers of messaging to enhance a person's knowledge to the level of curiosity. Presently, there is no intelligent system that combines the context free and context sensitive messages as visual inserts seamlessly.

This invention bridges the fundamental gap between printed book and audio book and takes it further in terms of technology, mechanism and process. The invention extends the visual insertions to podcast, advertisements, messages, and emergency preparedness. By selectively applying images and decoupling audio and images, the file transfer is strictly controlled based on the receiver's capability.

This disclosure shows an integrated insertion of visual picture, graph and other example static display or a combination thereof as a system and method. More particularly the disclosure details how to create a visual display of the relevant material while the podcast, talk or the lecture is being electronically transmitted on mobile devices. The software applications themselves may operate on a variety of devices, including servers, processors and mobile devices.

During listening to Podcasts, electronic relay of lectures on mobile devices and just verbal communication via electronic media the conveyor often mentions to a graph or a chart or a visual impression of an object or data which is available in his book but not while listening to a podcast. It becomes very frustrating if that is not available or one has to look in on another device what he or she is conveying. Since most of are listening to these media while we are walking or driving it would be beneficial to display this on a device screen or a dash board screen so we can understand the context of the lecture or talk. Our solution is an integrated resource that would enable a podcast creator or a book content creator to integrate the visual data to add at an appropriate time and for a given time frame to be displayed and then change to another at a specific section when anything else is mentioned.

In the proposed methodology, we show how such an intelligent system can be created where the visual inserts can optimally and adaptively be executed for the people as an individual, or as a group collocated in a building or dispersed geographically.

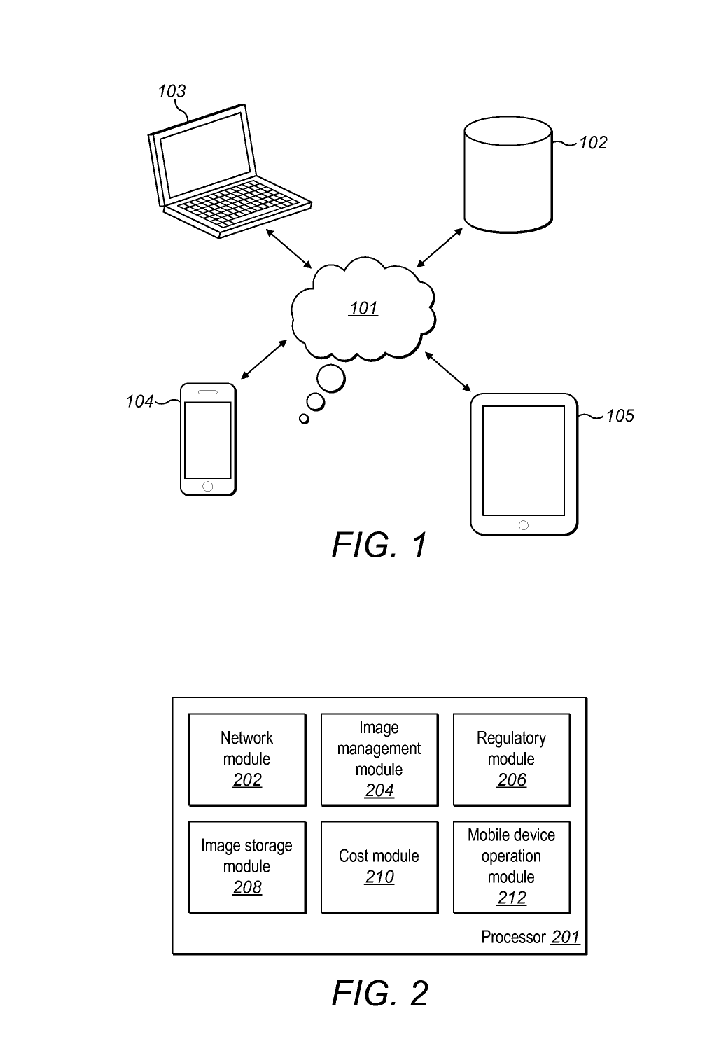

FIG. 1 illustrates a system view of the integrated visual data management system being used by different types of hardware. The software called visual data integrated management software may be installed either locally or in cloud for a single user or multiple users. The hardware may be a laptop 103, a computer/mobile device 104 and/or 105. They may be connected through a network 101 and the data may be stored in a database 102. The software may be installed on a central server or on a local device processor.

FIG. 2 is an illustration of a processor that may contain several modules, but not just limited to these, in a particular instance. Network module 202 is found in traditional project management software. In the instant integration of all the modules of image management module 204, network module 202, regulatory module 206 to check permits and copyright issues, image storage module 208 to harvest images from text version of the files to be tagged for proper time, space and duration for insertion in an audio file and store the comparison data with audio file location and text, cost module 210 to generate revenue via advertisement or on a paid preview model for sing the audio files in any format and mobile device operation module 212 to manage disparate operating system and making them a seamless integration system is value added proposition. Existing indicators such as network module and regulatory module alone is not adequate to monitor project progress. Instant invention incorporates several factors based on integrated approach to enhance the user experience and display static visual data for a podcast or an electronic relay of thoughts such as books and lectures. All these a part of an adaptive content management system.

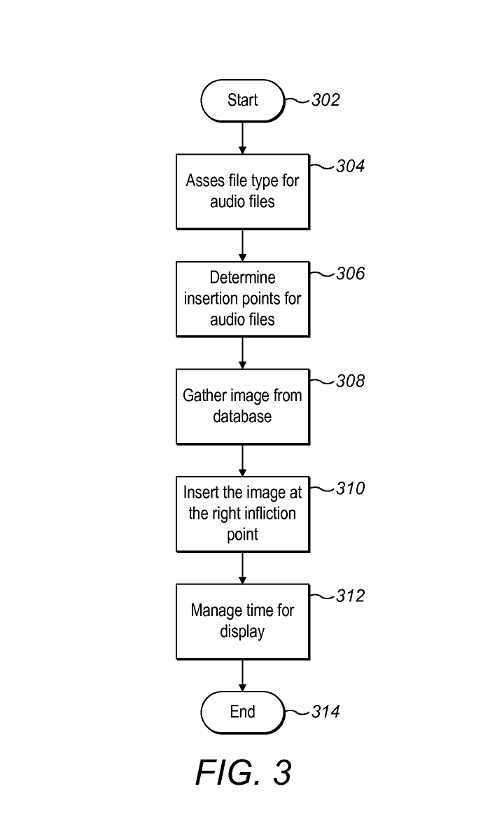

FIG. 3 illustrates a representation of a method flow that incorporates various aspects of module input and runs on hardware such as a processor to make it a seamless system for the user. Prior permit is obtained from content providers and copyright issues are taken care of. If customer figures are to be incorporated to further enhance the experience due permits are obtained from content owners. This can be flagged using regulatory module 206 to alert the user that permission needs to be obtained or the permission is granted.

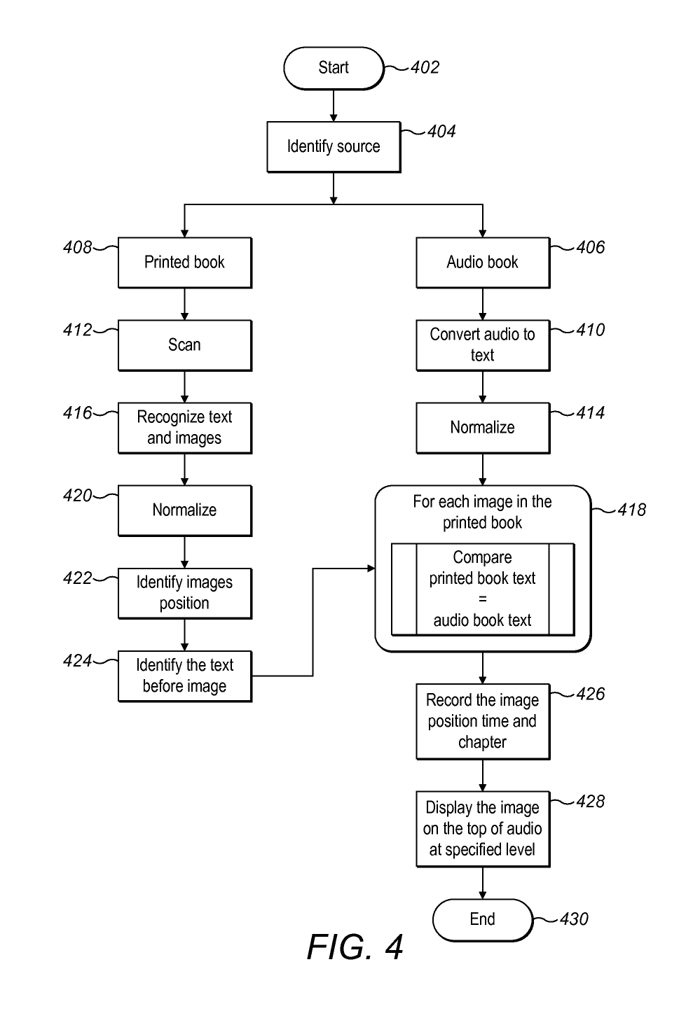

FIG. 4 illustrates the work flow for combining audio books and printed books and to integrate the image for the user to use on any electronic device including mobile device. The flow starts 402 by identifying the source 404 if it is a printed book 408 or a audio book 406. The printed books are scanned 412. The images and text are recognized 416 and normalized 420 to accommodate any format that needs insertion later in audio book 406. The identification of image positions are done 422 and the exact location of the text before or after the image 424 is recorded.

In one embodiment, a system and method for the audio book 406 the audio may be converted to text 410 in the back end. The converted file may be normalized 414 to match the normalized file 420. For each image in the printed book the position and location and timing may be compared to that of the audio that has been converted to text 418. This would allow the system and method to locate and time the insertion while the user is requesting or automatically it would be populated. After the comparison the recording of the image position, time and chapter location or just location 426 may be done and stored in image storage module 208. Finally the display of the image while the audio is playing at specific location 428 is done and management of the time and duration of the display is done 312. The process ends 430 once the audio file has finished playing.

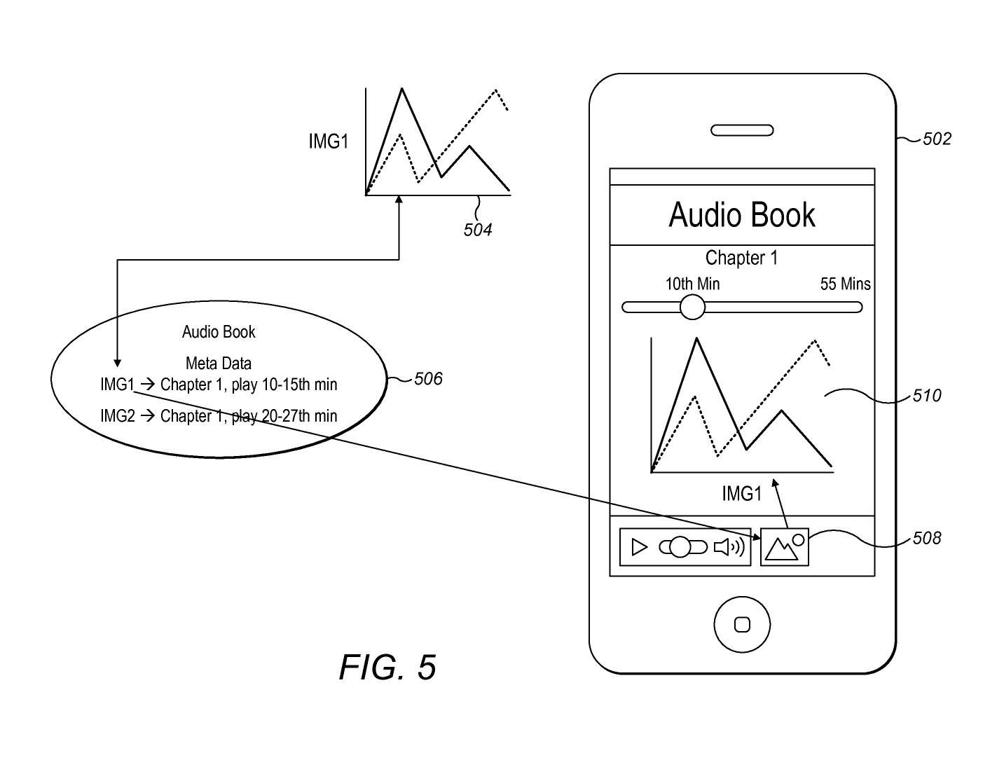

FIG. 5 illustrates a block diagram illustration on how visual images are displayed in Audio Books. Section 506 contains the Audio Book data file and it also contains the Metadata related to the visual images and their time to display the images like when and what image to display on the screen. Ex. this can be any images like graphs, charts and can be small video clips. Section 504 is an actual graph image that needs to be displayed between 10th and 15th min during audio playback. Section 502 is the total time length for the Chapter of the Audio File. Section 510 is the Actual image display area. The Image will be displayed only the time specified, in our Example, IMG1 will be displayed between 10th-15th min. Section 508 is an image display ON/OFF button. This button will be OFF by default during driving. The images obtained may be stored and retrieved from image storage module 208.

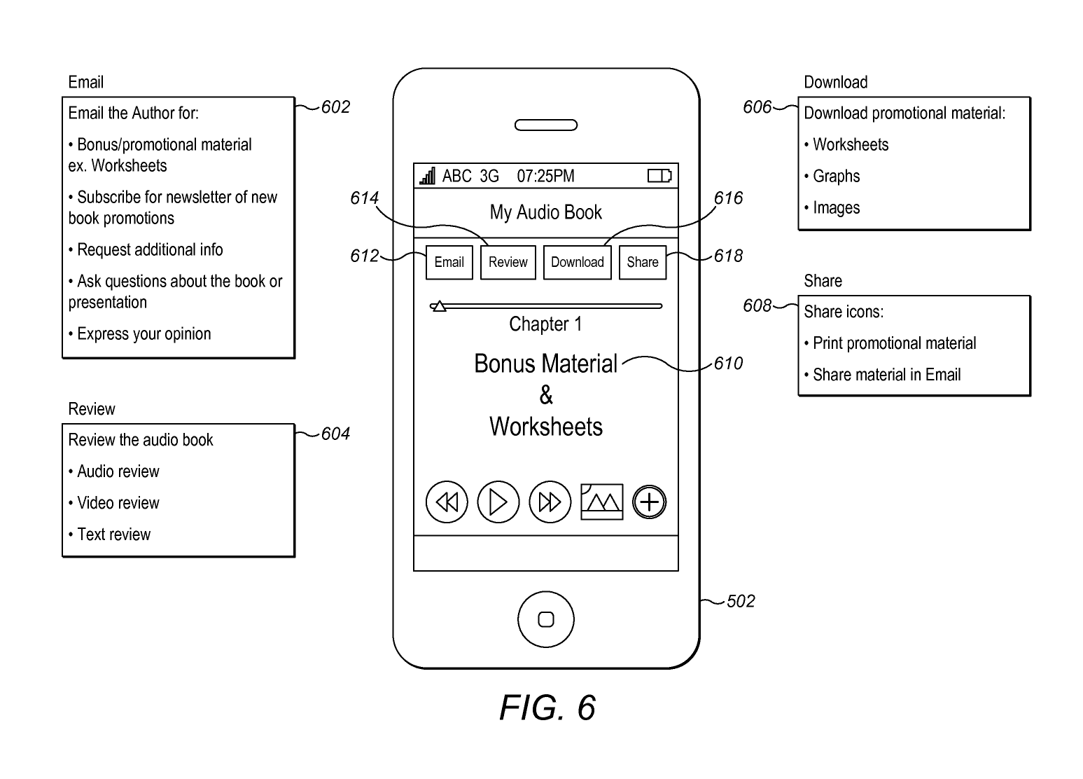

FIG. 6 illustrates a way to get the additional Bonus material or Worksheets from the Author or a managing party. This will be useful for the author to collect his audience contacts for any future promotions or to build a customer database. Box 602 is for Email access 612 Bonus/Promotional Material, Ex. Work Sheets, Subscribe for Newsletter or New Book promotions, Request Additional info, Ask Questions about the Book or Presentation, Express your opinion. Box 604 is about Audio Book Review 614 by the user. The Listener can review the Audio book/Podcast by doing Audio, Video and Text Review. These reviews can be posted to the Main Audio Book/Podcast Review site. Icon 606 is for downloading 616 any Promotion material that author want to share 618 like worksheets, graphs etc. Box 608 is about sharing with other relevant services like printing promotion material and Email. Icon 610 is used for Bonus material information.

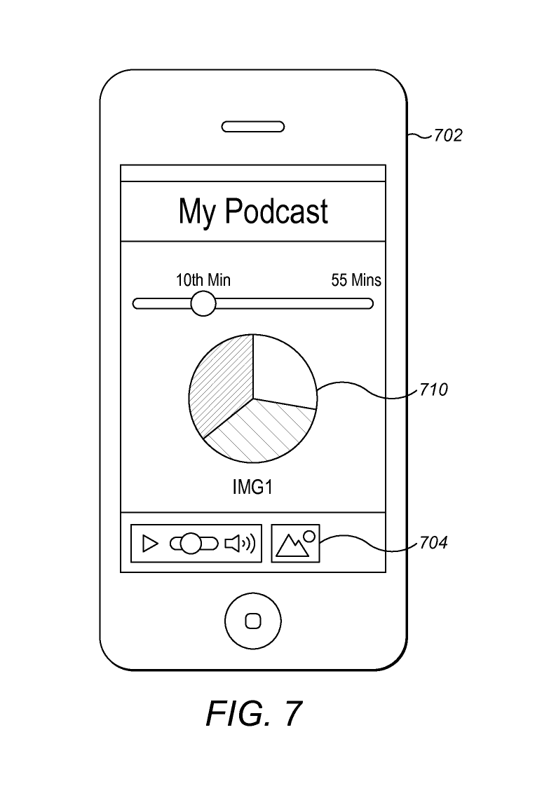

FIG. 7 illustrates a pod cast how an image of a graph or chart 710 may be displayed using the flow chart decision tree to insert the images 704 at an appropriate time and duration 702. This enhances the user experience on small and big screen mobile devices. The technological advancement of this invention is the algorithm specifically developed to tackle issues arising out of the content providers or application developers for mobile device and adding the missing factors as a graph or a figure or a cartoon to enhance the experience of the user.

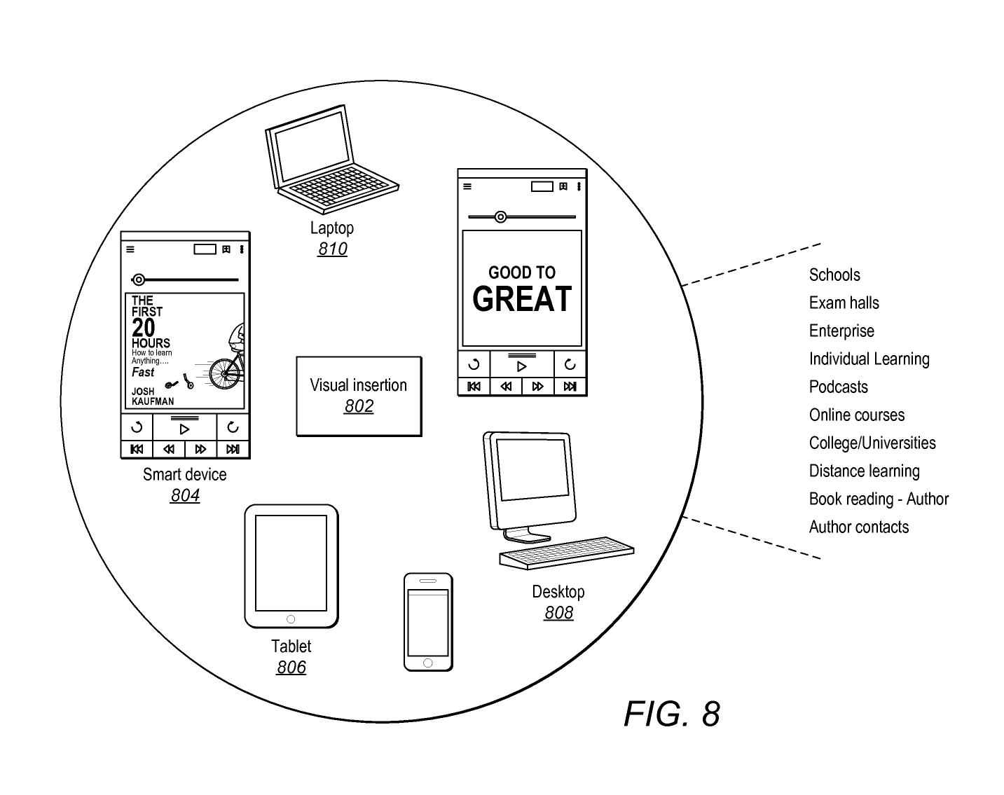

FIG. 8 illustrates the visual insertion 802 e-learning sphere of influence. Visual insertion process 802 is very important in the e-learning. With the advent of Internet, distance learning and on-line learning has become a reality with thousands obtaining degrees. Most do not even stay in the same continent. Group distance learning happens in schools, colleges and universities. Podcasts also happen to exam halls, enterprises and online training. In addition, when an author releases a book, they have book reading assignments from author where readers login and listen, where visual insertion makes sense to understand the context. Audiobooks with visual insertion is accessed by the user through smart devices 804, tablets 806, desktops 808 and laptops 810.

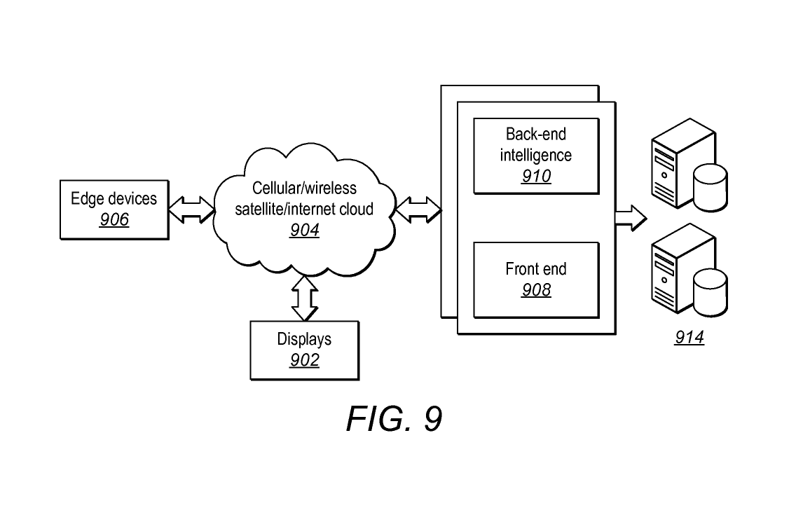

FIG. 9 illustrates the visual insertion intelligence high level network architecture. The users are reached through Internet brought either by a wired or a wireless, cellular, satellite Internet 904. The visual insertions are directed to the end user through edge devices 906 such as smart phones, laptops and tablets. The visuals can also be displayed to a group audience through digital displays 902 such as monitors and TV screens. The visual insertion intelligence is present in a cloud based backend system 904 that can be accessed through Internet. The system caters to the front end interfaces 908 and backend intelligence 910. The audiobook and visuals are stored in knowledgebase 914 with redundancy.

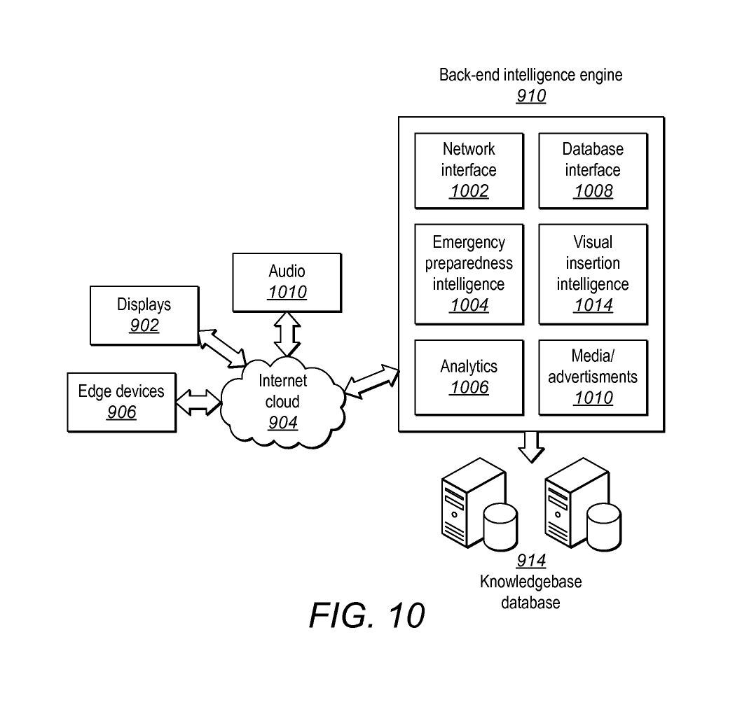

FIG. 10 illustrates the cloud based backend expert system intelligence system components. The end to end architecture shows the interactions between various systems to provide the visual insertion, digital media and emergency preparedness messages. The users access the audiobook with visual inserts using edge devices 906, common digital displays 902 and common audio systems 1010. The data is transferred over an Internet cloud 904 that can be wired, wireless, and cellular or satellite based system. The backend intelligence engine 910 resident in cloud provides the function of streaming audiobook, visual inserts, and digital messages for emergency preparedness and advertisements. The backend intelligence consists of network interface 1002 which interfaces with the network devices. It also consists of the database interface 1008 which interacts with the knowledge database 914 where audiobook and visual insert repositories are maintained. Emergency preparedness intelligence 1004 module provides the context free and context sensitive emergency preparedness messages based on the user location and profile. Visual insertion intelligence 1014 module provides the context free and context sensitive visual inserts to the audiobook with causality. It keeps the state in-tact and provides the inserts based on where the customer is in terms of audiobook location at a given time. It proactively transfers insert data to avoid delays. Analytics module 1006 provides the important user statistics based on customer profile, behavior, audiobook access methods and changes. Media advertisements 1010 module provides the important context free and context sensitive media and advertisements to the users based on analytics, profile, location and time.

FIGS. 9 and 10 together illustrate the back-end intelligence 910 of the two major functionalities emergency preparedness 1004 and visual insertion 1014.

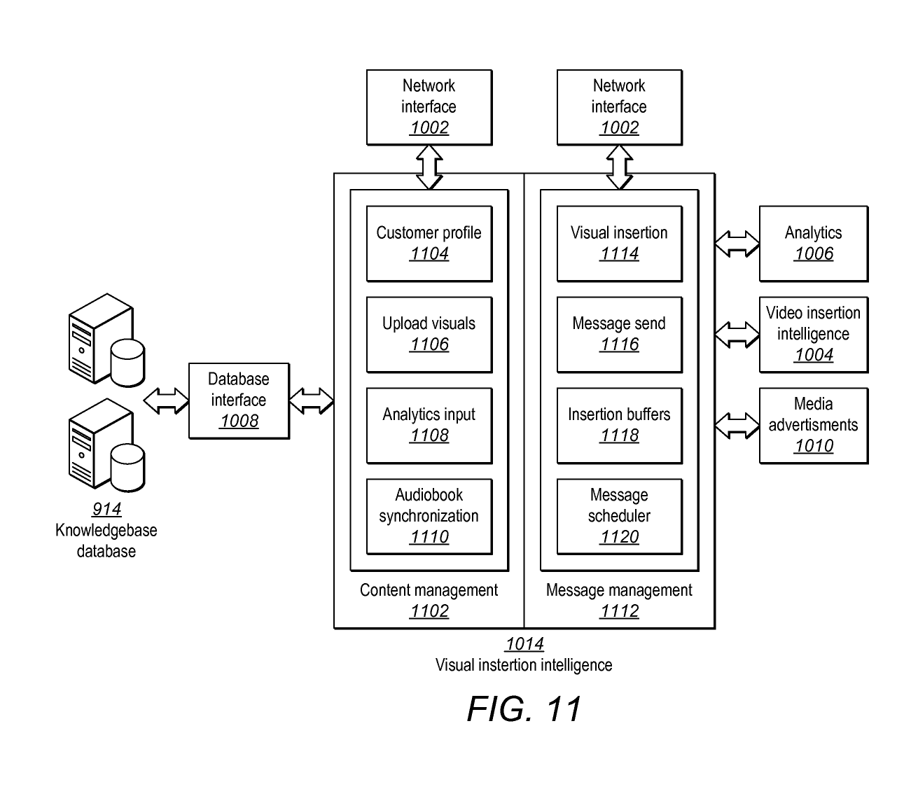

FIG. 11 illustrates the video insertion intelligence module 1014 dependencies. This module is part of image management module 204. The video insertion intelligence module 1014 is a function within the back-end expert system intelligence 910. It consists of two major components, content management 1102 and message management 1112. It has dependency to network interface 1002, through which the packets and messages arrive and depart. The content management 1102 consists of customer profile 1104, upload visuals 1106, analytics input 1108 and audio book synchronization 1110. Customer profile 1104 is invoked for authentication, profiles and user preferences when a new user logs in. The information is obtained through database interface 1008 from the knowledgebase database 914. When a set of visuals need to be obtained for audiobook, upload visuals 1106 gets it from the knowledgebase 914 through database interface 1008. Similarly an audiobook is obtained and synchronized to the visuals 1110 by getting the audiobook from the knowledgebase 914 through database interface 1008.

Message management module 1112 deals with the system handling of the messages and packets. Ultimately an audiobook and the visual inserts are synchronized based on user reading state and converted to packets and messages and sent across to the user devices. The visual insertion 1114 module intelligently combines the audiobook stream to provide proper insertions. Message send 1116 module marshals the messages in a form that it can be sent. Insertion buffer module 1118 creates proper memory spaces for the packets and messages for it to be streamlined as one sequence containing visual inserts into audiobooks. Message schedule 1120 module schedules the packets proactively so that user receives it on time to maintain user reading state.

The visual insertion intelligence 1014 is dependent on analytics 1006 module for providing user analytics so media messages can be buffered and scheduled along with audiobook and visual insertions. In one embodiment, Emergency preparedness intelligence 1004 module provides context free and context sensitive messages based on profile and location to be buffered and scheduled along with audiobook and visual inserts. In one embodiment, Media advertisements 1010 module provides context free and context sensitive digital media messages to be scheduled along with visual inserts and audiobook.

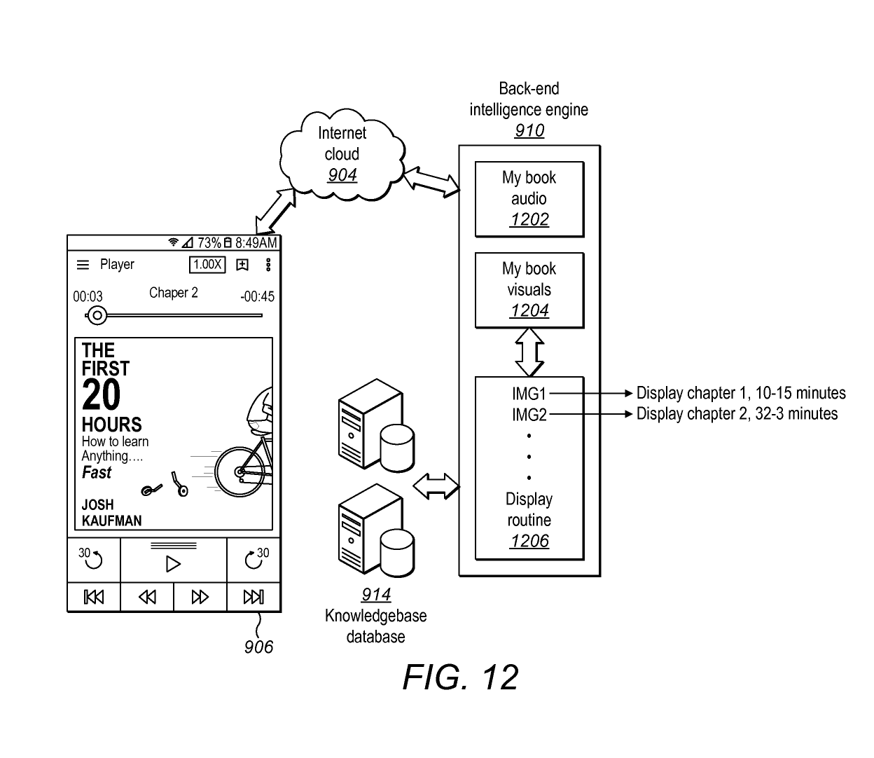

FIG. 12 illustrates the backend intelligence of an embodiment, combining audiobook with visual inserts to be scheduled. For example, my book audio 1202 is obtained from the knowledgebase 914 and synchronized 1110. My book visuals 1204 is uploaded 1106 from the knowledgebase 914. They both are combined into a display routine 1206 in visual insertion 1114 module. The combination, as shown in the illustration of 1206, shows the audiobook interspersed intelligently with a display of images with syntax on where and how many minutes. The combined message is scheduled 1120 and sent to the user interface 906 over Internet 904.

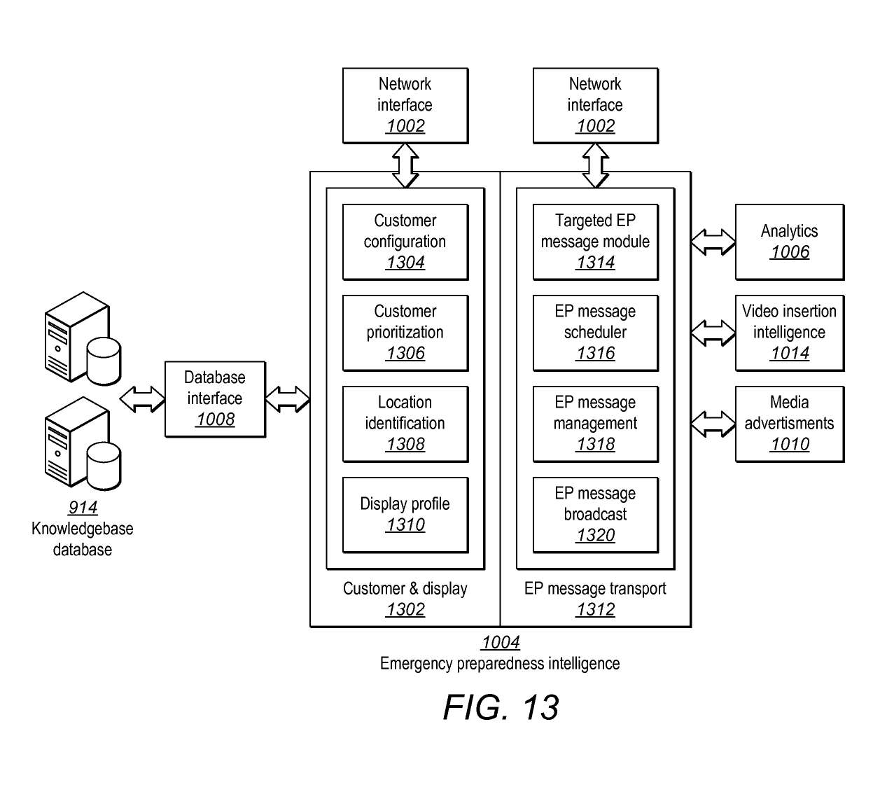

FIG. 13 illustrates the embodiment where emergency preparedness messages are displayed within the audiobook visual inserts. This module may be part of regulatory module 206 or may be independent of it. The emergency preparedness intelligence 1004 module consists of customer and display submodule 1302 and the emergency preparedness message transport submodule 1312. The customer and display 1302 submodule manages the user data. Customer configuration 1304 function provides the preferences of the user on how and what they want in terms of the feature. Customer prioritization 1306 function provides the information on customer priority. The customer configuration information is obtained from the knowledgebase 914 through database interface 1008. The location identification 1308 module interfaces with the network interface 1002 to get the GPS or triangulation information of the user from the smart devices. The display profile 1310 function interfaces with the database 914 to find the appropriate emergency preparedness display messages based on context and location.

In one embodiment, targeted emergency preparedness message function 1314 forms the context sensitive messaging based on GPS, location and analytics 1006 information. The emergency preparedness message scheduler 1316 schedules the message that is obtained periodically for a user that is both context free and context sensitive. The message could be within a video insertion 1014 or part of advertisement 1010. The emergency preparedness message can be timed or event based and is managed 1318 per user or group basis. If it is a group, then the emergency preparedness message is broadcast 1320 over the network interface 1002.

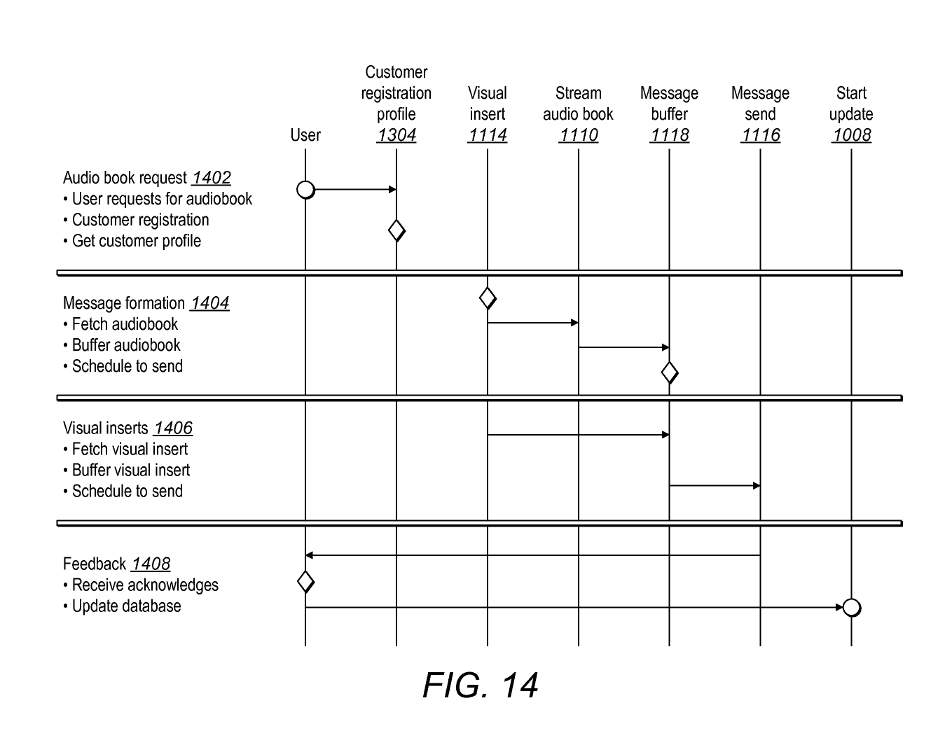

FIG. 14 illustrates the visual insertion use case. When an audiobook request 1402 is made, the user requests audiobook in the user interface as part of the app within smart device. The customer registration is invoked within the backend intelligence 1304 for verification of the user after obtaining the customer profile from the database 914. The requested audiobook is transferred from the knowledgebase 914 and buffered 1118 and scheduled to be sent 1116 by proper messaging 1404. The audiobook is parsed and visual inserts 1406 locations are identified by the visual insert intelligence. The visual inserts 1114 are fetched, buffered and scheduled along with streamed audiobook 1110 for the user. The audiobook and visual insertion is transferred to the user and a feedback 1408 received from the user, which is updated in database. The user state 1008 is updated from request to read.

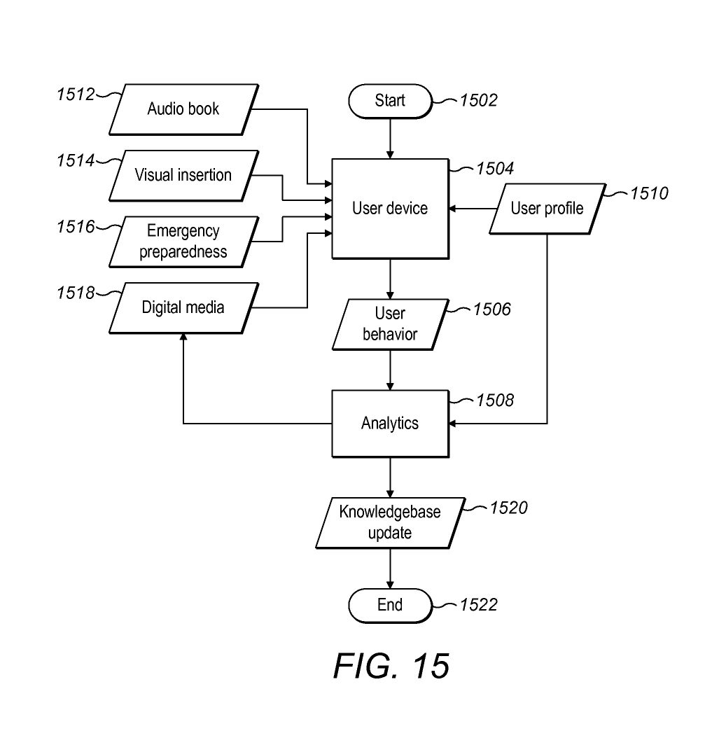

FIG. 15 illustrates the functional flowchart of the visual inserted audiobook. In one embodiment, the audiobook 1512 is transferred to user device 1504 as-is. In another embodiment, visual insertion 1514 is transferred to the user device 1504 along with audiobook 1512. In another embodiment, emergency preparedness messages 1516 are transferred to the user device 1504 along with audiobook 1512 and visual insertion 1514. Finally, in another embodiment, digital media messages and advertisement 1518 are sent to user devices 1504 along with audiobook 1512 and visual insertion 1514. The user when reading through user device 1504 pauses, reads, re-reads, rewinds, fast forwards, waits, aborts or resets. This user behavior 1506 is captured and sent to analytics module 1508 that affects the messages 1518 sent back to the user. This feedback is refined intelligently on a continuous basis and the knowledgebase is updated 1520. The user profile updates 1510 done independently affect the user access criterion and analytics data collection 1508. For example, an user may be allowed privacy for a fee and hence analytics is disabled!

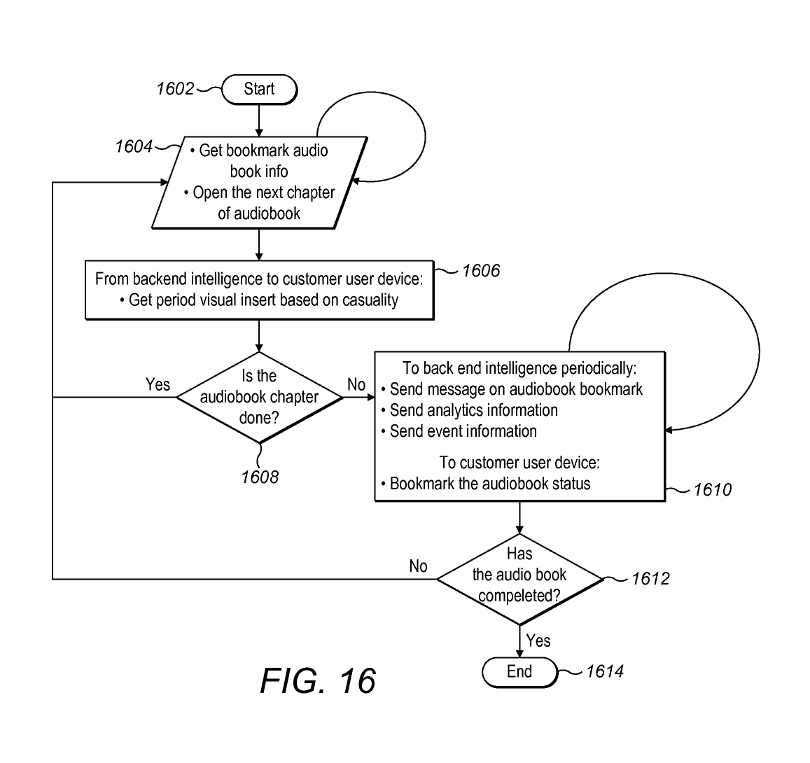

FIG. 16 illustrates the system description work flow. In one embodiment the user gets an audiobook and opens a bookmark 1602 and the backend intelligence 1606 continuously and proactively provides visual insert to the audiobook based on causality. If the audio book chapter is read 1608, the user continuous to the next chapter 1604. The backend intelligence periodically receives message on audiobook bookmark, obtains analytics and event information 1610. The event information could be a pause, skip, rewind, or fast forward. If the audiobook is not completed, the whole cycle is done again and again chapter by chapter. The state of the user device is made sure to be consistent by the back end intelligence. In essence an end to end intelligent visual insertion system for a user to visualize intelligent content while listening to audio content is presented. An integrated enterprise system residing in a hardware using a visual insertion intelligence module to include display of a visual data (eg.: figure, table, graph or movie clip) for a verbal electronic broadcast on an edge device; a network module that enables an adaptive content and context manager to communicate efficiently with a content creator and the content user using a cloud based and an Internet based system; a back end intelligence engine to perform insertion and creation methodology for the visual data in real-time and manage the implication of change between a voice and a video; and a cloud based expert system that provides a visual insert for an audio broadcast for users to listen at their time of convenience is developed.

In addition, it will be appreciated that the various operations, processes, apparatuses and methods disclosed herein may be embodied in a machine-readable medium and/or a machine accessible medium compatible with a data processing system (e.g., a computer system), and may be performed in any order (e.g., including using means for achieving the various operations). Accordingly, the specification and drawings are to be regarded in an illustrative rather than a restrictive sense.

What is claimed is:

1. An end to end intelligent visual insertion system, comprising;
an integrated enterprise system residing in a hardware using a visual insertion intelligence module to include display of a visual data for a verbal electronic broadcast on an edge device;
a network module that enables an adaptive content and context manager to communicate efficiently with a content creator and the content user using a cloud based and an Internet based system;
a back end intelligence engine to perform insertion and creation methodology for the visual data in real-time and manage the implication of change between a voice and a video; and
a cloud based expert system that provides a visual insert for an audio broadcast for users to listen at their time of convenience.

2. The system of claim 1, further comprising:
a targeted telephony and chat service to customers for discussion with the authors;
a network module for data connectivity to download additional reference materials;
a back end intelligence engine for a targeted advertisement to customer's interest and to enhance and suggest selections;
the back end intelligence engine to promote a context sensitive advertisement to a group of customers based on their perceived interest learnt through analytics; and
a location based services in area near customer's geographical position.

3. A method for end to end intelligent visual insertion, comprising:
identifying a source of a content in a text file, audio file, video file or a combination thereof;
scanning the text file, audio file, video file or a combination thereof to locate the text or image location;
normalizing a file content in the text file, audio file, video file or a combination thereof to calculate a position, time and duration to perform the intelligent visual insertion of a figure, table, graph or movie clip;
removing the intelligent visual insertion after an electronic document length has passed; and
allowing a user to retrieve the figure, table, graph or movie clip whenever they want to review it on an electronic device.
